(19) United States
(12) Patent Application Publication
(10) Pub. No.: US 2019/0301238 A1
(43) Pub. Date: Oct. 3, 2019

(54) RESISTANCE MECHANISM FOR CORD OF WINDOW COVERING

(71) Applicant: Nien Made Enterprise Co., Ltd., Taichung (TW)

(72) Inventor: Chih-Yao Chang, Taichung City (TW)

(21) Appl. No.: 16/011,656

(22) Filed: Jun. 19, 2018

(30) Foreign Application Priority Data
Mar. 29, 2018 (CN) 201820440451.0

(51) Int. Cl. E06B 9/323; E06B 9/322

(52) U.S. Cl. CPC E06B 9/323; E06B 2009/3225; E06B 9/322

(57) ABSTRACT

A resistance mechanism is adapted to provide friction force to a cord of a window covering. The cord, accompanied by opening and closing the window covering, could be driven to move in a wound direction and a released direction, respectively. The resistance mechanism includes a resistance member including a resistance wheel. The resistance wheel is adjacent to the cord, and a section of the cord corresponding to the resistance wheel is wound around the resistance wheel. When the cord is driven to move in the wound direction or the released direction, the resistance wheel operably rotates in a first direction.

### BACKGROUND OF THE INVENTION

### 1. Field of the Invention

The present disclosure relates generally to a resistance mechanism for opening and closing a window covering, and more particularly to a resistance mechanism generating a resistance force to a cord of the window covering.

### 2. Description of the Prior Art

A conventional cordless window covering includes a headrail, a bottom rail and a covering material. The bottom rail is positioned under the headrail, and the covering material is positioned between the headrail and the bottom rail. In addition, a spring box is usually used as a driving module in the conventional cordless window covering for winding or releasing a cord, and is usually positioned in the headrail. The spring box includes a reel, a driving wheel and a spiral spring, wherein the reel meshes with the driving wheel, and one end of the spiral spring is fixedly connected to the driving wheel. One end of the cord is connected to the reel, and the other end thereof is connected to the bottom rail after passing through the covering material.

When the bottom rail is pulled away from the headrail to unfold the covering material, the cord would be released from the reel by the movement of the bottom rail, and the reel would be rotated by the movement of the cord simultaneously. At the same time, the reel drives the driving wheel to rotate, so that the spiral spring is wound around the driving wheel, and thereby to store energy. In contrast, when the bottom rail is pushed close to the headrail to fold the covering material, the rewinding force from the spiral spring would drive the driving wheel to rotate, and thereby to drive the reel to wind the cord.

Besides, when the pushing force (or the pulling force) applying to the bottom rail is removed, the bottom rail could stay at a desired position through the balance among the weights of the bottom rail and the covering material, the rewinding force from the spiral spring and the friction between the cord and other components of the window covering. However, in the conventional cordless window covering, the values of the weights of the bottom rail and the covering material and the rewinding force from the spiral spring could be approximately calculated only, but could not be measured accurately. Therefore, in practice, it's common to have the problem that the rewinding force from the spiral spring is too strong or too weak. For example, when the rewinding force from the spiral spring is too strong, it would be not easy to pull the bottom rail to unfold the covering material. For the rewinding force from the spiral spring is too strong, and the weights of the bottom rail and the covering material are too light, the bottom rail would not stay at the lowest position. On the other way, when the rewinding force from the spiral spring is too weak, it would not be easy to push the bottom rail to fold the covering material; for the weights of the bottom rail and the covering material are too heavy, which the rewinding force from the spiral spring cannot counterbalance, the bottom rail would not stay at the highest position.

Therefore, it is a problem needed to be solved that how to make the bottom rail of the cordless window covering easy to move, and easy to stay at a desired position.

### SUMMARY OF THE INVENTION

In view of the above, the primary objective of the present invention provides a resistance mechanism for a cord of a window covering. When the cords of the window covering are moved in one direction, the resistance mechanism would provide friction force to the cords of the window covering; when the cords of the window covering are moved in another one direction, the resistance mechanism would not provide friction force to the cords of the window covering.

To achieve the above objective, the present invention provides a resistance mechanism adapted to provide friction force to a cord of a window covering. The cord, accompanied by opening and closing the window covering, could be driven to move in a wound direction and a released direction, respectively. The resistance mechanism includes a resistance member including a resistance wheel. The resistance wheel is adjacent to the cord, and a section of the cord corresponding to the resistance wheel is wound around the resistance wheel. When the cord is driven to move in the wound direction or the released direction, the resistance wheel operably rotates in a first direction.

In addition, the present invention provides another resistance mechanism adapted to provide friction force to a cord of a window covering. The resistance mechanism includes a resistance member including a resistance wheel. The resistance wheel is adjacent to the cord, and a section of the cord corresponding to the resistance wheel is wound around the resistance wheel, so that the resistance wheel could be accompanied by the movement of the cord to rotate. When the cord is pulled in a released direction, the resistance wheel could be driven to rotate in the first direction. When the cord is pulled in the wound direction, the resistance wheel could be driven to also rotate in the first direction.

In embodiments of the present invention, the resistance mechanism further includes an active wheel. The cord has one end connected to the active wheel, and the active wheel operably rotates to wind up or release the cord, whereby the cord could move in the wound direction and or the released direction. The resistance member could be operated to connect in series to or to separate from the active wheel, and when the resistance member is connected in series to the active wheel, the active wheel drives the resistance wheel to rotate in the first direction.

In embodiments of the present invention, the resistance mechanism further includes a control member adapted to control the resistance member to be connected in series to or separated from the active wheel, and when the resistance member is connected in series to the active wheel, the resistance wheel is driven by the active wheel to rotate in the first direction.

In embodiments of the present invention, the resistance mechanism further includes a carrier, and the resistance member and the active wheel are positioned on the carrier. The carrier has a groove, and the resistance member can move along the groove, whereby the resistance member and the active wheel could be connected in series to or separated from each other.

In embodiments of the present invention, the groove has one end close to the active wheel, and the other end thereof is away from the active wheel. The resistance wheel has a shaft movably positioned in the groove, and thereby the resistance wheel could be operably moved close to or away from the active wheel along the groove. When the resistance wheel is moved close to the active wheel along the groove until the resistance wheel is connected in series to the active wheel, the resistance wheel would be driven by the active wheel to rotate in the first direction.

In embodiments of the present invention, when the active wheel winds up the cord, the resistance wheel is drawn by the cord to move close to the active wheel along the groove until the resistance wheel is connected in series to the active wheel, so that the active wheel drives the resistance wheel to rotate in the first direction, and at the same time, the rotation direction of the resistance wheel is opposite to the direction of the cord moving against a surface of the resistance wheel; when the cord is released from the active wheel, the resistance wheel is drawn by the cord to move away from the active wheel along the groove, whereby the resistance wheel is separated from the active wheel, and at the same time, the resistance wheel is driven by the cord to rotate in the first direction.

In embodiments of the present invention, the active wheel has a first toothed disk, and the resistance wheel has a second toothed disk; the first toothed disk and the second toothed disk operably mesh with each other, and thereby the resistance wheel could be driven by the active wheel to rotate.

In embodiments of the present invention, when the distance between the resistance wheel and the active wheel is a first distance, the resistance wheel and the active wheel are connected in series to each other; when the distance between the resistance wheel and the active wheel is a second distance, the resistance wheel and the active wheel are separated from each other, and the second distance is greater than the first distance.

In embodiments of the present invention, the resistance member further includes an intermediate wheel positioned on the carrier; the intermediate wheel is constantly connected in series to the active wheel, and the intermediate wheel could be driven by the active wheel to connect in series to or to separate from the resistance wheel; the groove has one end close to the resistance wheel, and the other end thereof is away from the resistance wheel; the intermediate wheel has a shaft positioned in the groove, whereby the intermediate wheel could be moved close to or away from the resistance wheel along the groove; when the intermediate wheel is driven by the active wheel to move close to the resistance wheel along the groove until the intermediate wheel is connected in series to the resistance wheel, the resistance wheel is driven by the active wheel through the intermediate wheel to rotate in the first direction.

In embodiments of the present invention, when the active wheel winds up the cord, the active wheel drives the intermediate wheel to move close to the resistance wheel along the groove until the intermediate wheel is connected in series to the resistance wheel, whereby the active wheel drives the resistance wheel to rotate in the first direction through the intermediate wheel; at the same time, the rotation direction of the resistance wheel is opposite to the direction of the cord moving against a surface of the resistance wheel; when the cord is released from the active wheel, the intermediate wheel is driven by the active wheel to move away from the resistance wheel along the groove, so that the intermediate wheel would be separated from the resistance wheel, and at the same time, the resistance wheel is driven by the cord to rotate in the first direction.

In embodiments of the present invention, the cord is released from the active wheel, the active wheel drives the intermediate wheel to move close to the resistance wheel along the groove until the intermediate wheel is connected in series to the resistance wheel, whereby the active wheel drives the resistance wheel to rotate in the first direction through the intermediate wheel, and at the same time, the rotation direction of the resistance wheel is opposite to the direction of the cord moving on the resistance wheel; when the active wheel winds up the cord, the intermediate wheel is driven by the active wheel to move away from the resistance wheel along the groove, whereby the intermediate wheel is separated from the resistance wheel, and at the same time, the resistance wheel would be driven by the cord to rotate in the first direction.

In embodiments of the present invention, the active wheel has a first toothed disk, the resistance wheel has a second toothed disk, and the intermediate wheel has a third toothed disk; the intermediate wheel is constantly connected in series to the active wheel, so that the third toothed disk and the first toothed disk constantly mesh with each other; when the active wheel drives the intermediate wheel to move along the groove until the intermediate wheel is connected in series to the resistance wheel, the third toothed disk and the second toothed disk would mesh with each other, and thereby the resistance wheel would be driven by the active wheel to rotate in the first direction.

In embodiments of the present invention, when the distance between the resistance wheel and the intermediate wheel is a third distance, the resistance wheel and the intermediate wheel are connected in series to each other; when the distance between the resistance wheel and the intermediate wheel is a fourth distance, the resistance wheel and the intermediate wheel are separated from each other, and the fourth distance is greater than the third distance.

The purpose of the present invention is that, when the cord is wound and released, the resistance member could operably rotate in the same direction, so that the resistance member would provide resistance to the cord while the cord is wound or released.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will be best understood by referring to the following detailed description of some illustrative embodiments in conjunction with the accompanying drawings, in which:

FIG. 1 is a perspective view of a cordless window covering of the present invention;

FIG. 2 is a perspective view of a spring box according to a first embodiment of the present invention;

FIG. 3 is a front view of the spring box according to the first embodiment of the present invention;

FIG. 4 is a sectional top view along line 4-4 of FIG. 3, wherein a resistance wheel meshes with a reel;

FIG. 5 is a sectional top view of the spring box of the first embodiment of the present invention, wherein the resistance wheel is separated from the reel;

FIG. 6 is a perspective view of a spring box according to a second embodiment of the present invention;

FIG. 7 is a front bottom view of the spring box according to the second embodiment of the present invention;

FIG. 8 is a front view of the spring box according to the second embodiment of the present invention;

FIG. 9 is a sectional top view along line 9-9 of FIG. 8, wherein a resistance wheel meshes with an intermediate wheel;

FIG. 10 is a sectional top view of the spring box of the second embodiment of the present invention, wherein the resistance wheel is separated from the intermediate wheel;

FIG. 11 is a sectional top view of a spring box of a third embodiment of the present invention, wherein a resistance wheel meshes with an intermediate wheel;

FIG. 12 is a sectional top view of the spring box of the third embodiment of the present invention, wherein the resistance wheel is separated from the intermediate wheel;

FIG. 13 is a perspective view of a spring box according to a fourth embodiment of the present invention;

FIG. 14 is a front view of the spring box according to the fourth embodiment of the present invention;

FIG. 15 is a sectional top view along line 15-15 of FIG. 14, wherein a resistance wheel is separated from an intermediate wheel;

FIG. 16 is a sectional top view of the spring box of the fourth embodiment of the present invention, wherein the resistance wheel meshes with the intermediate wheel;

FIG. 17 is a sectional top view of a spring box of a fifth embodiment of the present invention, wherein a resistance wheel is separated from an intermediate wheel; and

FIG. 18 is a sectional top view of the spring box of the fifth embodiment of the present invention, wherein the resistance wheel meshes with the intermediate wheel.

### DETAILED DESCRIPTION

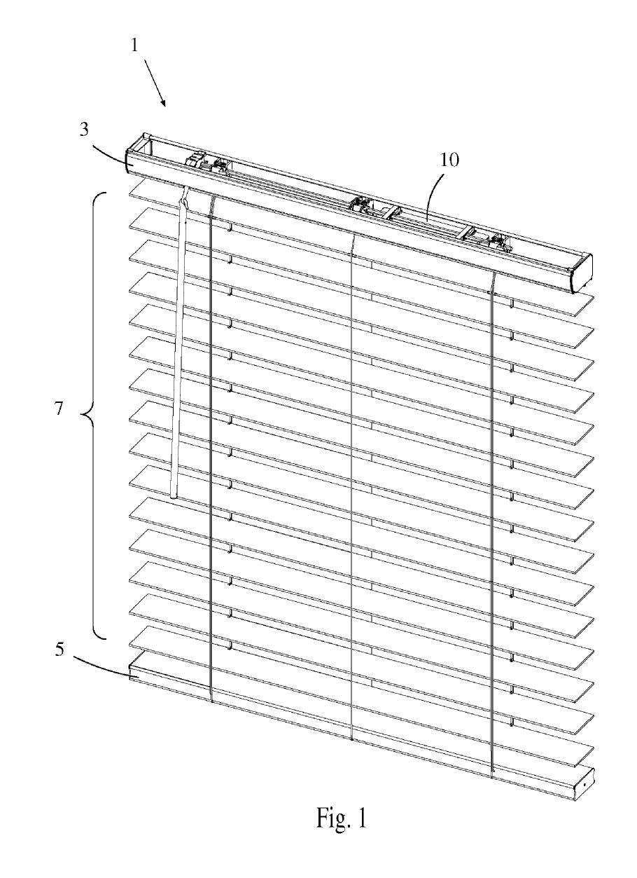

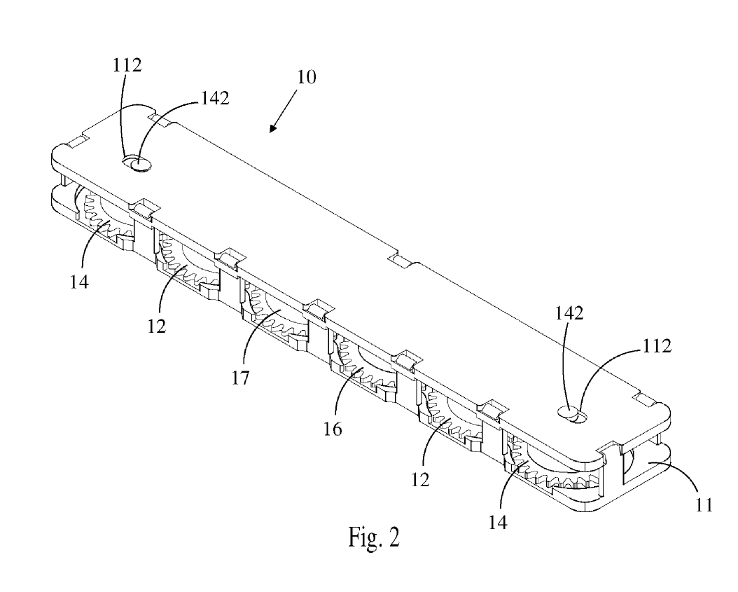

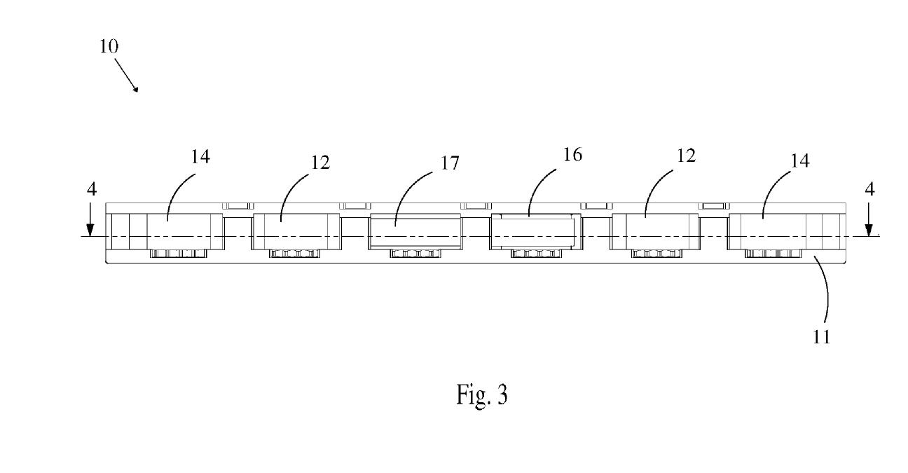

For easily understanding the present invention, several embodiments and accompanying drawings are illustrated as the following. Referring to FIG. 1, according to one embodiment of the present invention, a cordless window covering 1 includes a headrail 3, a bottom rail 5 and a covering material 7, wherein the bottom rail 5 is under the headrail 3, and the covering material 7 is between the headrail 3 and the bottom rail 5. Referring to FIG. 2 to FIG. 5, a spring box 10 (i.e., a resistance mechanism) is adapted to be a driving module in the cordless window covering 1 for winding up or releasing a cord 2, and is positioned in the headrail 3. The spring box 10 includes a reel 12 (i.e., an active wheel), a friction wheel 14 (i.e., a resistance wheel), a driving wheel 16 and a spiral spring 17, wherein the reel 12 and the driving wheel 16 mesh with each other, and one end of the spiral spring 17 is fixedly connected to the driving wheel 16. Besides, the cord 2 has one end connected to the reel 12, and the other end thereof passes through the covering material 7 to connect to the bottom rail 5.

When the bottom rail 5 is pulled away from the headrail 3 to unfold the covering material 7, the cord 2 is driven by the bottom rail 5 to release from the reel 12, and the reel 12 rotates along with the movement of the cord 2. At the same time, the reel 12 drives the driving wheel 16 to rotate, and thereby the spiral spring 17 is wound around the driving wheel 16, in order to store energy. On the other hand, when the bottom rail 5 is pushed close to the headrail 3 to fold the covering material 7, the rewinding force from the spiral spring 17 could drive the driving wheel 16 to rotate, whereby to drive the reel 12 to wind up the cord 2.

In FIG. 2 to FIG. 5, the spring box 10 further includes a base board 11, on which the reel 12 and the friction wheel 14 are positioned. The base board 11 has a groove 112, wherein one end of the groove 112 is close to the reel 12 and the other end thereof is away from the reel 12. The friction wheel 14 has a shaft 142 located in the groove 112, so that the friction wheel 14 could move along the groove 112, whereby the friction wheel 14 could be operated to move close to and away from the reel 12 along the groove 112. In the current embodiment, both of a top board and the base board 11 of the spring box 10 have grooves 112, as shown in FIG. 2, and thereby the shaft 142 of the friction wheel 14 could be stably pivoted in and moved along the grooves 112, but it is not limited thereto; the groove 112 could be merely formed on one of the top board and the base board 11. In addition, the friction wheel 14 is adjacent to the cord 2, and the cord 2 is wound around the friction wheel 14. In detail, the cord 2 is wound around and contacted the friction wheel 14, and a section of the cord 2 corresponding to the friction wheel 14 could be around the friction wheel 14 in a circle or not in a circle. In the current embodiment, the friction wheel 14 and the reel 12 respectively have a toothed disk, and when the friction wheel 14 is moved close to the reel 12 until the toothed disks of both mesh with each other, the reel 12 could drive the friction wheel 14 to rotate. In addition to the meshing of gears, the friction wheel and the reel could be operated simultaneously by other transmission mechanisms, e.g., a belt and a chain.

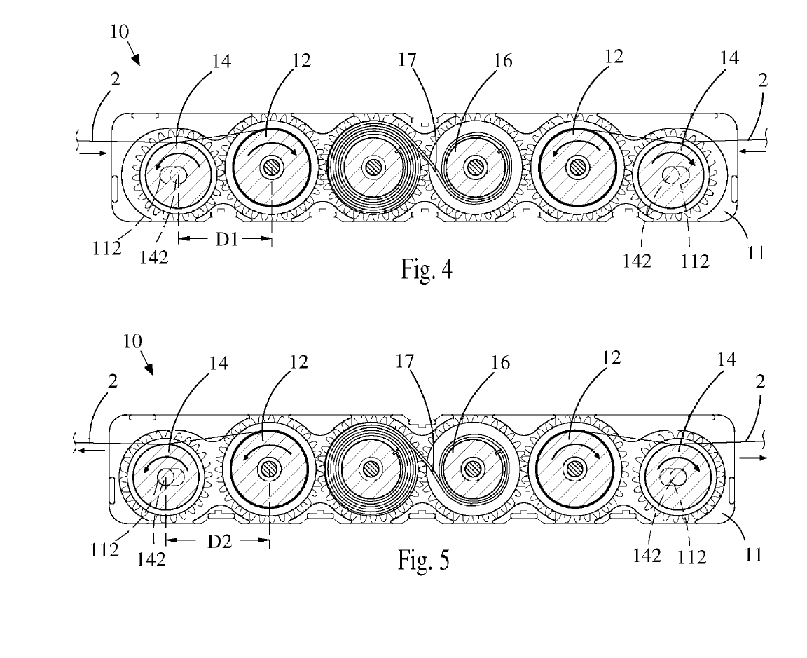

Specifically, referring to the right side of FIG. 4, the cord 2 is wound around the reel 12 counterclockwise, and is wound around the friction wheel 14; therefore, when the reel 12 is driven by the driving wheel 16 to wind up the cord 2, the reel 12 rotates counterclockwise. At the same time, the cord 2 would draw the friction wheel 14 to move close to the reel 12 until the friction wheel 14 is connected in series to the reel 12, and thereby the reel 12 drives the friction wheel 14 to rotate clockwise, wherein the clockwise direction is defined as a first direction. At the moment, the cord 2 counterclockwise moves on the surface of the friction wheel 14, which is opposite to the first direction (i.e., clockwise direction) of the friction wheel 14; that is, when the cord 2 is wound around the reel 12, the friction wheel 14 provides friction resistance to the cord 2.

Referring to the right side of FIG. 5, when the bottom rail 5 is pulled to unfold the covering material 7, the cord 2 is released from the reel 12. At the same time, the friction wheel 14 would be drawn away from the reel 12 by a pulling force applied to the bottom rail 5 through the cord 2, whereby the friction wheel 14 is separated from the reel 12, so that the friction wheel 14 could be driven by the cord 2 to rotate clockwise (i.e., to rotate in the first direction), and therefore, the friction wheel 14 does not provide the friction resistance to the cord 2 at the moment.

In addition, in FIG. 4, the friction wheel 14 and the reel 12 are connected in series to each other, and at this moment, the distance between the both is defined as a first distance (D1); in FIG. 5, the friction wheel 14 and the reel 12 are separated from each other, and at this moment, the distance between the both is defined as a second distance (D2); the second distance (D2) is greater than the first distance (D1).

When the pulling force applied to the bottom rail 5 is removed after the bottom rail 5 of the cordless window covering 1 is pulled to a predetermined position, the weights of the bottom rail 5 and the covering material 7 could be less than the rewinding force from the spiral spring 17, and therefore the bottom rail 5 would be pulled upward. At this moment, the rewinding force from the spiral spring 17 could slightly pull the cord 2 through the reel 12, whereby the cord 2 could draw the friction wheel 14 to move close to the reel 12 until the friction wheel 14 and the reel 12 mesh with each other, so that the friction wheel 14 would provide friction resistance to the cord 2. At the same time, the friction resistance between the friction wheel 14 and the cord 2 could counterbalance the weights of the bottom rail 5 and the covering material 7 and the rewinding force from the spiral spring 17, in order to make the bottom rail 5 to stably stay at the predetermined position. On other aspects, for the friction wheel 14 could provide the friction resistance to the cord 2 while the cord 2 being wound, it could prevent the cord 2 from being wound too fast to cause the loops of the cord 2 twisting with one another. In addition, through the arrangement of the friction wheel 14 and the cord 2, the friction wheel 14 does not provide the friction resistance to the cord 2 while the cord 2 being released, so that the bottom rail 5 could be easily pulled to unfold the covering material 7.

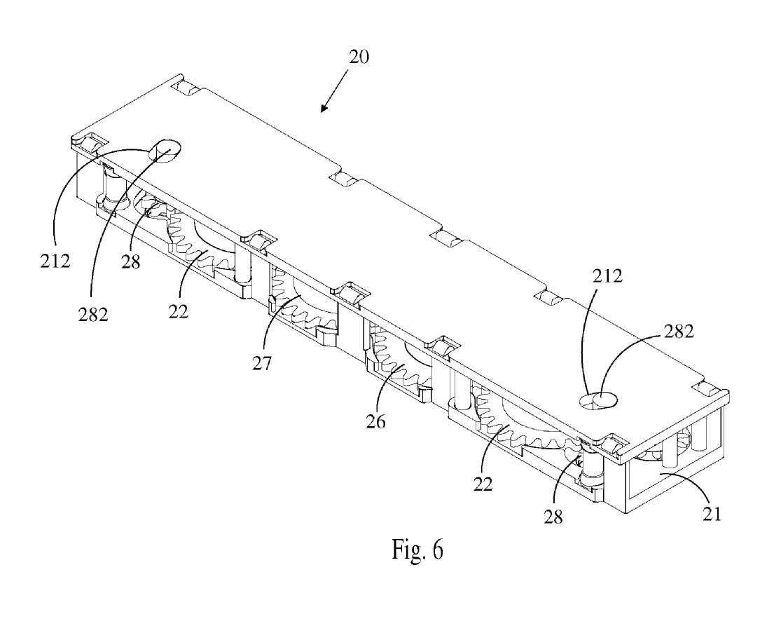

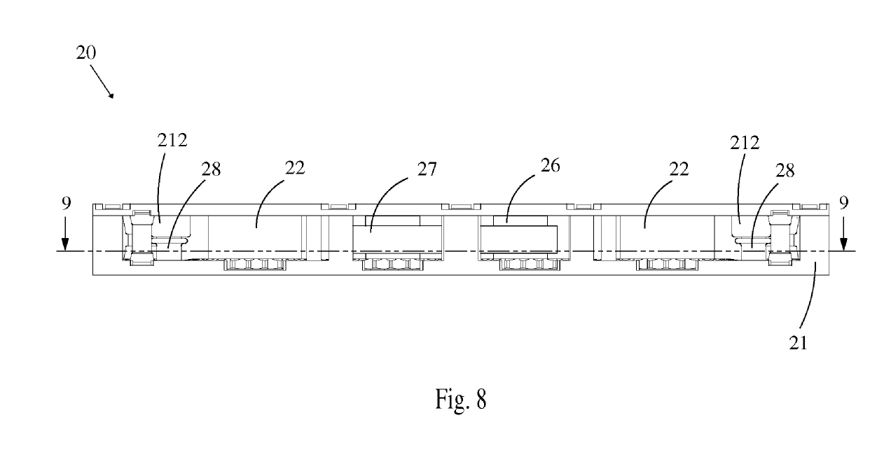

Referring to FIG. 6 to FIG. 10, a spring box 20 of a second embodiment of the present invention is also adapted to the cordless window covering 1. The spring box 20 includes a reel 22, a friction wheel 24, a driving wheel 26, an assistant wheel 28 (i.e., an intermediate wheel) and a spiral spring 27, wherein the reel 22 and the assistant wheel 28 mesh with each other, the reel 22 and the driving wheel 26 mesh with each other and one end of the spiral spring 27 is fixedly connected to the driving wheel 26. Besides, a cord 2a has one end connected to the reel 22, and the other end thereof passes through the covering material 7 to connect to the bottom rail 5. The friction wheel 24 is adjacent to the cord 2a, and the cord 2a is wound around the friction wheel 24.

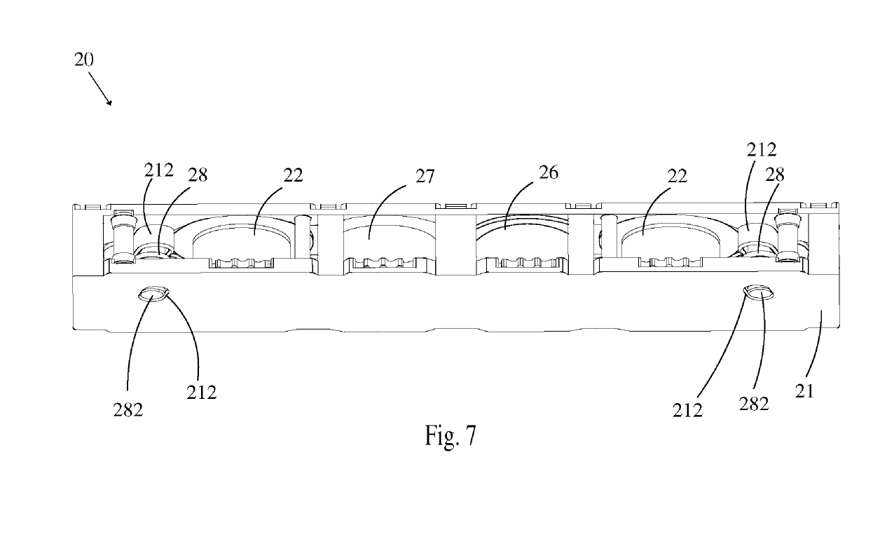

In the current embodiment, the spring box 20 further includes a base board 21, on which the reel 22, the friction wheel 24, and the assistant wheel 28 are positioned. The base board 21 has a groove 212, wherein one end of the groove 212 is close to the friction wheel 24 and the other end thereof is away from the friction wheel 24. The assistant wheel 28 has a shaft 282 located in the groove 212, so that the assistant wheel 28 could move along the groove 212, whereby the assistant wheel 28 could be operated to move close to and away from the friction wheel 24 along the groove 212. In the current embodiment, both of a top board and the base board 21 of the spring box 20 have grooves 212, as shown in FIG. 6 and FIG. 7, and thereby the shaft 282 of the assistant wheel 28 could be stably pivoted in and moved along the grooves 212, but it is not limited thereto; the groove 212 could be merely formed on one of the top board and the base board 21. In detail, due to the meshing between the reel 22 and the assistant wheel 28, the reel 22 could drive the assistant wheel 28 to rotate, and can operate the assistant wheel 28 to move close to or away from the friction wheel 24 along the groove 212.

The friction wheel 24 and the assistant wheel 28 respectively have a toothed disk, and when the assistant wheel 28 is moved close to the friction wheel 24 until the toothed disks of both mesh with each other, the assistant wheel 28 could drive the friction wheel 24 to rotate. However, In addition to the meshing of gears, the friction wheel 24 and the assistant wheel could be operated simultaneously by other transmission mechanisms, e.g., a belt and a chain.

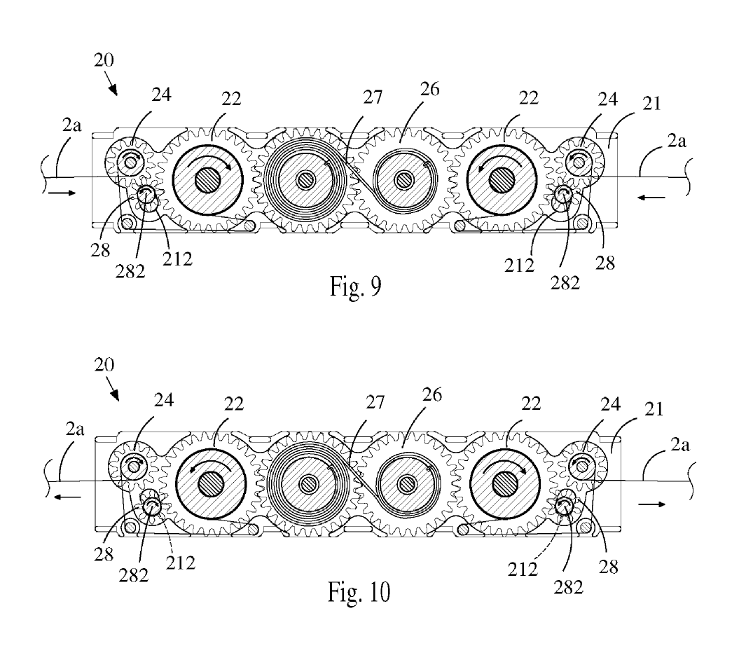

Referring to the right side of FIG. 9, the cord 2a is wound around the reel 22 counterclockwise, and is wound around the friction wheel 24; therefore, when the reel 22 is driven by the driving wheel 26 to wind up the cord 2a, the reel 22 rotates counterclockwise, and drives the assistant wheel 28 to move close to the friction wheel 24 until the assistant wheel 28 is connected in series to the friction wheel 24, and thereby the assistant wheel 28 is driven by the reel 22 to rotate clockwise. After the assistant wheel 28 and the friction wheel 24 are connected in series to each other, the reel 22 drives the friction wheel 24 to rotate counterclockwise through the assistant wheel 28, wherein the counterclockwise direction is defined as a first direction. At the moment, the cord 2a clockwise moves on the surface of the friction wheel 24, which is opposite to the first direction (i.e., counterclockwise direction) of the friction wheel 24; that is, when the cord 2a is wound around the reel 22, the friction wheel 24 provides friction resistance to the cord 2a.

Referring to the right side of FIG. 10, when the bottom rail 5 is pulled to unfold the covering material 7, the cord 2a is released from the reel 22. At the same time, the reel 22 would be driven to rotate clockwise by a pulling force applied to the bottom rail 5 through the cord 2a, whereby the assistant wheel 28 could be driven by the clockwise rotating reel 22 to move away from the friction wheel 24, and therefore the assistant wheel 28 would be separated from the friction wheel 24, so that the friction wheel 24 could be driven by the cord 2a to rotate counterclockwise (i.e., to rotate in the first direction). Therefore, the friction wheel 24 does not provide the friction resistance to the cord 2a at the moment.

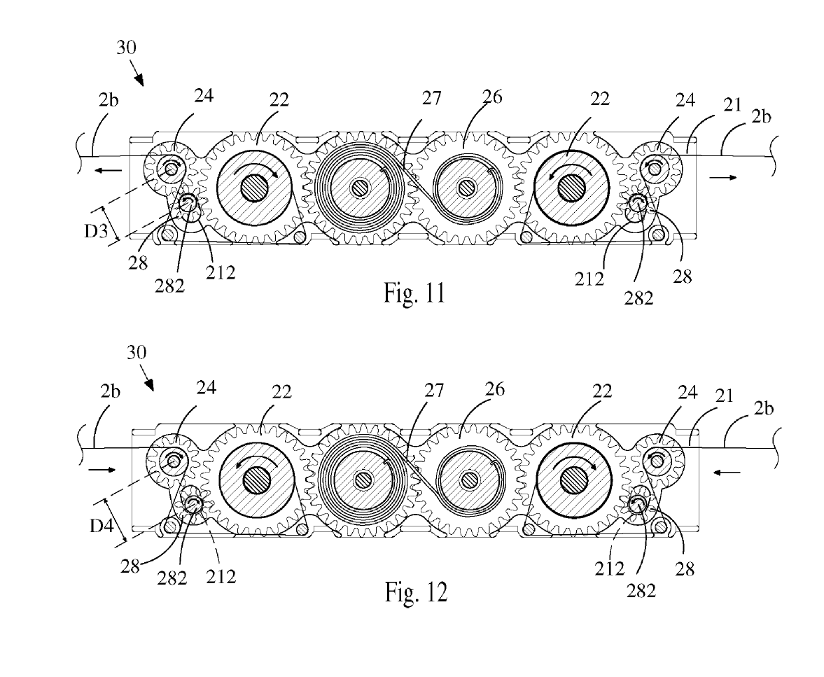

Referring to FIG. 11 and FIG. 12, a spring box 30 of a third embodiment of the present invention is provided, which is similar to the spring box 20 of the second embodiment. However, the third embodiment is different from the second embodiment, wherein the winding direction of a cord 2b in the spring box 30 of the third embodiment is different from that of the cord 2a in the spring box 20 of the second embodiment.

Referring to the right side of FIG. 11, when the bottom rail 5 is pulled to unfold the covering material 7, the cord 2b is released from the reel 22. At the same time, the reel 22 would be driven to rotate counterclockwise by a pulling force applied to the bottom rail 5 through the cord 2b, whereby the assistant wheel 28 could be driven by the counterclockwise rotating reel 22 to move close to the friction wheel 24 until the assistant wheel 28 is connected in series to the friction wheel 24, and thereby the assistant wheel 28 is driven by the reel 22 to rotate clockwise. After the assistant wheel 28 and the friction wheel 24 are connected in series to each other, the reel 22 drives the friction wheel 24 to rotate counterclockwise through the assistant wheel 28, wherein the counterclockwise direction is defined as a first direction. At the moment, the cord 2b clockwise moves on the surface of the friction wheel 24, which is opposite to the first direction (i.e., counterclockwise direction) of the friction wheel 24; that is, when the cord 2b is wound around the reel 22, the friction wheel 24 provides friction resistance to the cord 2b.

Referring to the right side of FIG. 12, the cord 2b is wound around the reel 22 clockwise, and is wound around the friction wheel 24; therefore, when the reel 22 is driven by the driving wheel 26 to wind up the cord 2b, the reel 22 rotates clockwise, and drives the assistant wheel 28 to move away from the friction wheel 24, and therefore the assistant wheel 28 would be separated from the friction wheel 24, so that the friction wheel 24 could be driven by the cord 2b to rotate counterclockwise (i.e., to rotate in the first direction). Therefore, the friction wheel 24 does not provide the friction resistance to the cord 2b at the moment.

When the pulling force applied to the bottom rail 5 is removed after the bottom rail 5 of the cordless window covering 1 is pushed to a predetermined position, the weights of the bottom rail 5 and the covering material 7 could be greater than the rewinding force from the spiral spring 27, and therefore the bottom rail 5 would be dropped downward. At this moment, the weights of the bottom rail 5 and the covering material 7 could drive the reel 22 to rotate counterclockwise through the cord 2b, whereby to drive the assistant wheel 28 to move close to the friction wheel 24 until the assistant wheel 28 and the friction wheel 24 mesh with each other, so that the friction wheel 24 would provide friction resistance to the cord 2b. At the same time, the friction resistance between the friction wheel 24 and the cord 2b could counterbalance the rewinding force from the spiral spring 27 and the weights of the bottom rail 5 and the covering material 7, in order to make the bottom rail 5 to stably stay at the predetermined position. In addition, through the arrangement of the friction wheel 24, the assistant wheel 28 and the cord 2b, the friction wheel 24 does not provide the friction resistance to the cord 2b while the cord 2b being wound, so that the bottom rail 5 could be easily pushed to fold the covering material 7.

In addition, in FIG. 11, the assistant wheel 24 and the friction wheel 24 are connected in series to each other, and at this moment, the distance between the both is defined as a third distance (D3); in FIG. 12, the assistant wheel 24 and the friction wheel 24 are separated from each other, and at this moment, the distance between the both is defined as a fourth distance (D4); the fourth distance (D4) is greater than the third distance (D3).

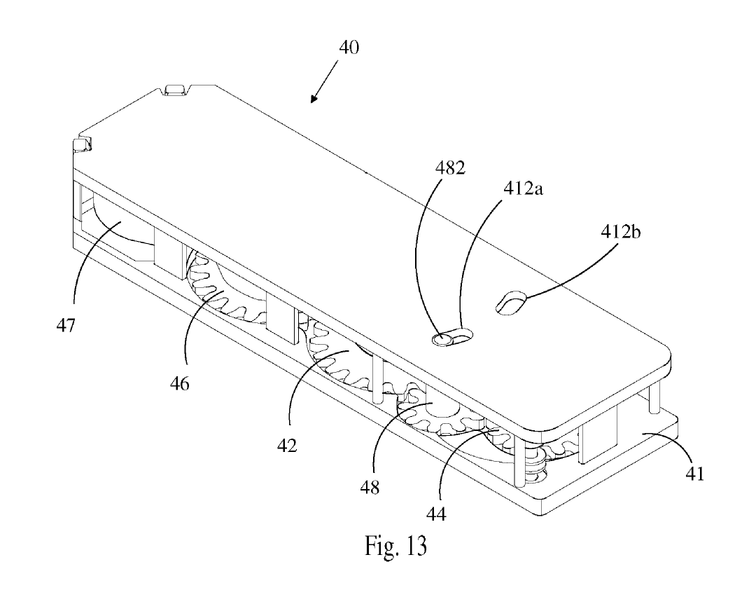

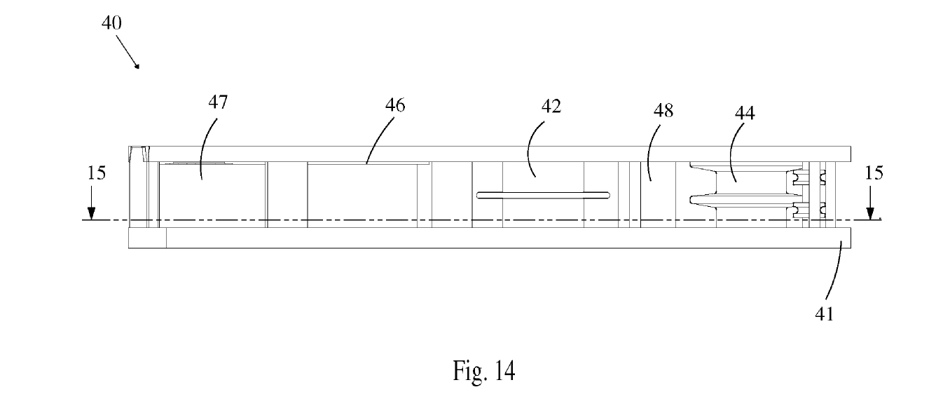

Referring to FIG. 13 to FIG. 16, a spring box 40 of a fourth embodiment of the present invention is also adapted to the cordless window covering 1. The spring box 40 includes a reel 42, a friction wheel 44, and an assistant wheel 48, wherein the arrangement, connection and operation of the reel 42, the friction wheel 44 and the assistant wheel 48 are similar to that of the reel 22, the friction wheel 24 and the assistant wheel 28 of the second embodiment. However, the fourth embodiment is different from the second embodiment, wherein the amounts of the reel 22, the friction wheel 24 and the assistant wheel 28 in the second embodiment are two, and all of them are arranged symmetrically, and thereby the two cords 2a could be wound or released by the reels 22 positioned at two opposite sides of the spring box 20, respectively. However, the spring box 40 of the fourth embodiment has only one reel 42, one friction wheel 44 and one assistant wheel 48, so that the cord 2 could be wound or released by the reel 42 positioned at only one side of the spring box 40.

In the current embodiment, the spring box 40 further includes a base board 41, on which the reel 42, the friction wheel 44, and the assistant wheel 48 are positioned. The base board 41 has two grooves 412a and 412b, wherein one end of each of the grooves 412a and 412b is close to the friction wheel 44 and the other end thereof is away from the friction wheel 44. In the current embodiment, the assistant wheel 48 has a shaft 482 located in the groove 412a, so that the assistant wheel 48 could move along the groove 412a, whereby the assistant wheel 48 could be operated to move close to and away from the friction wheel 44 along the groove 412a. In the current embodiment, both of a top board and the base board 41 of the spring box 40 have grooves 412a and 412b, as shown in FIG. 13, and thereby the shaft 482 of the assistant wheel 48 could be stably pivoted in and moved along the grooves 412a or 412b, but it is not limited thereto; the grooves 412a and 412b could be merely formed on one of the top board and the base board 41.

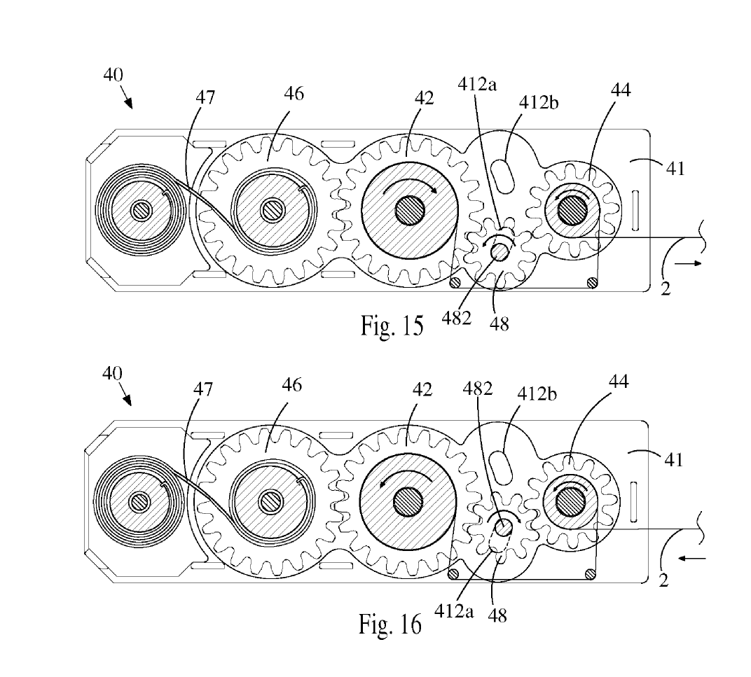

In FIG. 15, when the bottom rail 5 is pulled to unfold the covering material 7, the cord 2 is released from the reel 42. At the same time, the reel 42 would be driven to rotate clockwise by a pulling force applied to the bottom rail 5 through the cord 2, whereby the assistant wheel 48 could be driven by the clockwise rotating reel 42 to move away from the friction wheel 44, and therefore the assistant wheel 48 would be separated from the friction wheel 44, so that the friction wheel 44 could be driven by the cord 2 to rotate counterclockwise (i.e., to rotate in the first direction). Therefore, the friction wheel 44 does not provide the friction resistance to the cord 2 at the moment.

In FIG. 16, the cord 2 is wound around the reel 42 counterclockwise, and is wound around the friction wheel 44; therefore, when the reel 42 is driven by a driving wheel 46 to wind up the cord 2, the reel 42 rotates counterclockwise, and drives the assistant wheel 48 to move close to the friction wheel 44 until the assistant wheel 48 is connected in series to the friction wheel 44, and thereby the assistant wheel 48 is driven by the reel 42 to rotate clockwise. After the assistant wheel 48 and the friction wheel 44 are connected in series to each other, the reel 42 drives the friction wheel 44 to rotate counterclockwise through the assistant wheel 48, wherein the counterclockwise direction is defined as a first direction. At the moment, the cord 2 clockwise moves on the surface of the friction wheel 44, which is opposite to the first direction (i.e., counterclockwise direction) of the friction wheel 44; that is, when the cord 2 is wound around the reel 42, the friction wheel 44 provides friction resistance to the cord 2.

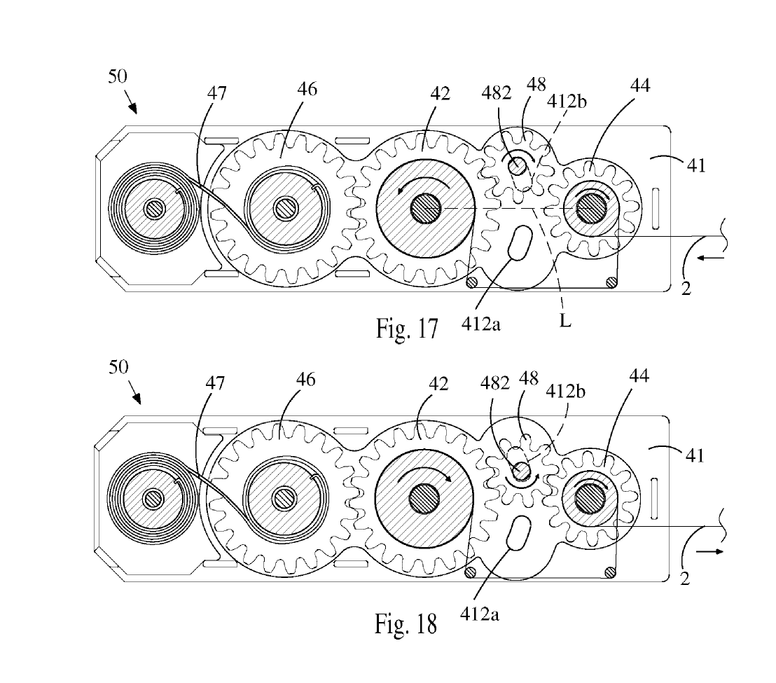

Referring to FIG. 17 and FIG. 18, a spring box 50 of a fifth embodiment of the present invention is provided, which is similar to the spring box 40 of the fourth embodiment. However, the fifth embodiment is different from the fourth embodiment, wherein the shaft 482 of the assistant wheel 48 in the fourth embodiment is in the groove 412a, but the shaft 482 of the assistant wheel 48 in the fifth embodiment is in the groove 412b. If the connection section between the axis of the friction wheel 44 and the axis of the reel 42 is defined as a line L, the grooves 412a and 412b are respectively formed at two opposite sides of the line L; further, the line L is a symmetrical line, and the grooves 412a and 412b are formed in line symmetry to the line L. For example, when the reel 42 rotates clockwise, if the shaft 482 of the assistant wheel 48 is in the groove 412a, the reel 42 would drive the assistant wheel 48 to move away from the friction wheel 44; in contrast, if the shaft 482 of the assistant wheel 48 is in the groove 412b, the reel 42 would drive the assistant wheel 48 to move close to the friction wheel 44.

Specifically, in FIG. 17, the cord 2 is wound around the reel 42 counterclockwise, and is wound around the friction wheel 44; therefore, when the reel 42 is driven by a driving wheel 46 to wind up the cord 2, the reel 42 rotates counterclockwise, and drives the assistant wheel 48 to move away from the friction wheel 44, and therefore the assistant wheel 48 would be separated from the friction wheel 44, so that the friction wheel 44 could be driven by the cord 2 to rotate clockwise, wherein the clockwise direction is defined as a first direction. Therefore, the friction wheel 44 does not provide the friction resistance to the cord 2 at the moment.

In FIG. 18, when the bottom rail 5 is pulled to unfold the covering material 7, the cord 2 is released from the reel 42. At the same time, the reel 42 would be driven to rotate clockwise by a pulling force applied to the bottom rail 5 through the cord 2, whereby the assistant wheel 48 could be driven by the clockwise rotating reel 42 to move close to the friction wheel 44, until the assistant wheel 48 is connected in series to the friction wheel 44, and thereby the assistant wheel 48 is driven by the reel 42 to rotate counterclockwise. After the assistant wheel 48 and the friction wheel 44 are connected in series to each other, the reel 42 drives the friction wheel 44 to rotate clockwise (i.e., to rotate in the first direction) through the assistant wheel 48. At the moment, the cord 2 clockwise moves on the surface of the friction wheel 44, which is opposite to the first direction (i.e., clockwise direction) of the friction wheel 44; that is, when the cord 2 is wound around the reel 42, the friction wheel 44 provides friction resistance to the cord 2.

When the cord is wound (or released), the friction wheel provided in the embodiments of the present invention could be operated to connect in series to the reel, and thereby the friction wheel could provide friction resistance to the cord; further, the friction resistance could counterbalance the weights of the bottom rail and the covering material and the rewinding force from the spiral spring, in order to make the bottom rail of the cordless window covering to stably stay at a predetermined position after an external force is removed. In contrast, when the cord is released (or wound), through the design of the embodiments of the present invention, the friction wheel does not provide the friction resistance to the cord, whereby the bottom rail could be easily moved to unfold (or fold) the covering material.

It must be pointed out that the embodiments described above are only some preferred embodiments of the present invention. All equivalent structures which employ the concepts disclosed in this specification and the appended claims should fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A resistance mechanism for a cord of a window covering, adapted to provide friction force to the cord of the window covering, comprising:
a resistance member including a resistance wheel, wherein the resistance wheel is adjacent to the cord, and a section of the cord corresponding to the resistance wheel is wound around the resistance wheel, whereby the resistance wheel is accompanied by the movement of the cord to rotate; when the cord is pulled in a released direction, the resistance wheel operably rotates in a first direction; when the cord is pulled in a wound direction, the resistance wheel also operably rotates in the first direction.

2. The resistance mechanism of claim 1, further comprising an active wheel, wherein the cord has one end connected to the active wheel, and the active wheel operably rotates to wind up or release the cord, whereby the cord is moved in the wound direction or the released direction; the resistance member is operably connected in series to or separated from the active wheel, and when the resistance member is connected in series to the active wheel, the active wheel drives the resistance wheel to rotate in the first direction.

3. The resistance mechanism of claim 2, further comprising a control member adapted to control the resistance member to be connected in series to or separated from the active wheel, wherein when the resistance member is connected in series to the active wheel, the resistance wheel is driven by the active wheel to rotate in the first direction.

4. The resistance mechanism of claim 3, further comprising a carrier, wherein the resistance member and the active wheel are positioned on the carrier; the carrier has a groove, and the resistance member can move along the groove, whereby the resistance member and the active wheel could be connected in series to or separated from each other.

5. The resistance mechanism of claim 4, wherein the groove has one end close to the active wheel, and the other end thereof is away from the active wheel; the resistance wheel has a shaft movably positioned in the groove, and thereby the resistance wheel is operably moved close to or away from the active wheel along the groove; when the resistance wheel is moved close to the active wheel along the groove until the resistance wheel is connected in series to the active wheel, the resistance wheel would be driven by the active wheel to rotate in the first direction.

6. The resistance mechanism of claim 5, wherein when the active wheel winds up the cord, the resistance wheel is drawn by the cord to move close to the active wheel along the groove until the resistance wheel is connected in series to the active wheel, so that the active wheel drives the resistance wheel to rotate in the first direction, and at the same time, the rotation direction of the resistance wheel is opposite to the direction of the cord moving against a surface of the resistance wheel; when the cord is released from the active wheel, the resistance wheel is drawn by the cord to move away from the active wheel along the groove, whereby the resistance wheel is separated from the active wheel, and at the same time, the resistance wheel is driven by the cord to rotate in the first direction.

7. The resistance mechanism of claim 2, wherein the active wheel has a first toothed disk, and the resistance wheel has a second toothed disk; the first toothed disk and the second toothed disk operably mesh with each other, and thereby the resistance wheel is able to be driven by the active wheel to rotate.

8. The resistance mechanism of claim 2, wherein when the distance between the resistance wheel and the active wheel is a first distance, the resistance wheel and the active wheel are connected in series to each other; when the distance between the resistance wheel and the active wheel is a second distance, the resistance wheel and the active wheel are separated from each other, and the second distance is greater than the first distance.

9. The resistance mechanism of claim 4, wherein the resistance member further comprises an intermediate wheel positioned on the carrier; the intermediate wheel is constantly connected in series to the active wheel, and the intermediate wheel is able to be driven by the active wheel to connect in series to or to separate from the resistance wheel; the groove has one end close to the resistance wheel, and the other end thereof is away from the resistance wheel; the intermediate wheel has a shaft positioned in the groove, whereby the intermediate wheel is able to be moved close to or away from the resistance wheel along the groove; when the intermediate wheel is driven by the active wheel to move close to the resistance wheel along the groove until the intermediate wheel is connected in series to the resistance wheel, the resistance wheel is driven by the active wheel through the intermediate wheel to rotate in the first direction.

10. The resistance mechanism of claim 9, wherein when the active wheel winds up the cord, the active wheel drives the intermediate wheel to move close to the resistance wheel along the groove until the intermediate wheel is connected in series to the resistance wheel, whereby the active wheel drives the resistance wheel to rotate in the first direction through the intermediate wheel; at the same time, the rotation direction of the resistance wheel is opposite to the direction of the cord moving against a surface of the resistance wheel; when the cord is released from the active wheel, the intermediate wheel is driven by the active wheel to move away from the resistance wheel along the groove, so that the intermediate wheel would be separated from the resistance wheel, and at the same time, the resistance wheel is driven by the cord to rotate in the first direction.

11. The resistance mechanism of claim 9, wherein the cord is released from the active wheel, the active wheel drives the intermediate wheel to move close to the resistance wheel along the groove until the intermediate wheel is connected in series to the resistance wheel, whereby the active wheel drives the resistance wheel to rotate in the first direction through the intermediate wheel, and at the same time, the rotation direction of the resistance wheel is opposite to the direction of the cord moving on the resistance wheel; when the active wheel winds up the cord, the intermediate wheel is driven by the active wheel to move away from the resistance wheel along the groove, whereby the intermediate wheel is separated from the resistance wheel, and at the same time, the resistance wheel would be driven by the cord to rotate in the first direction.

12. The resistance mechanism of claim 9, wherein the active wheel has a first toothed disk, the resistance wheel has a second toothed disk, and the intermediate wheel has a third toothed disk; the intermediate wheel is constantly connected in series to the active wheel, so that the third toothed disk and the first toothed disk constantly mesh with each other; when the active wheel drives the intermediate wheel to move along the groove until the intermediate wheel is connected in series to the resistance wheel, the third toothed disk and the second toothed disk would mesh with each other, and thereby the resistance wheel would be driven by the active wheel to rotate in the first direction.

13. The resistance mechanism of claim 9, wherein when the distance between the resistance wheel and the intermediate wheel is a third distance, the resistance wheel and the intermediate wheel are connected in series to each other; when the distance between the resistance wheel and the intermediate wheel is a fourth distance, the resistance wheel and the intermediate wheel are separated from each other, and the fourth distance is greater than the third distance.
